(19) United States
(12) Patent Application Publication
(10) Pub. No.: US 2007/0055638 A1
(43) Pub. Date: Mar. 8, 2007

(54) Device and method for comparing structural components

(75) Inventors: Steffen Kaup, Stuttgart (DE); Bernd Raizner, Holzgerlingen (DE); Konrad Stoehr, Rottenburg (DE); Florian Winkelmann, Calw (DE)

Correspondence Address: Davidson Davidson & Kappel, 485 Seventh Avenue 14th Floor, New York, NY, 10018, US

(73) Assignee: DaimlerChrysler AG, Stuttgart (DE)

(21) Appl. No.: 10/563,653

(22) PCT Filed: Jun. 29, 2004
(86) PCT No.: PCT/EP04/07018

§ 371 Date: Apr. 25, 2006

(30) Foreign Application Priority Data
Jul. 5, 2003 (DE) 103 30 447.9

(51) Int. Cl. G06F 17/00

(52) U.S. Cl. 705/400

(57) ABSTRACT

A device and a method for comparing calculations for product components used in different product types. According to the invention, a list of product types, a list of parts valid for all product types, a database comprising descriptions of structural parts and a database comprising calculations for the components is used. The descriptions and calculations relate to one component each on the list of parts and are specific of one product type each. Once a component is input, all descriptions and calculations for said component are determined and compared with each other. Said comparison allows to find the technical reasons for the differences in the calculations for the same component in different product types.

The present invention relates to a device and a method for comparing calculations for product components in different product types.

The different product types include, for example, motor vehicles from different automotive manufacturers in which parts supplied by many different suppliers are installed. There is a need for a method permitting a comparison of costs for supplied parts to make it possible to find “adjusting screws” for cost reductions based on technical features of the supplied parts.

An information system for components is known from US 2001/0023376 A1. A user inputs a specification for components into the information system. Components types that meet the specification are determined. To this end, the information system accesses various management systems, e.g., one for parts numbers, one for quality assurance, one for inventory management, one for distribution control, one for cost acquisition and monitoring, one for production planning, and one for sales control. The components thus determined are displayed in a certain order depending, for example, on the frequency of use and the degree of standardization of the particular component.

US 2001/0023376 A1 does not describe how the information about the components determined or the order in which the components determined are displayed is used to discover technical causes for differences between the components found.

DE 10213830 A1 describes a system and a method for comparing the manufacturing costs of various product variants and determining “adjusting screws” for cost reduction. The product variants are manufactured on the same manufacturing line, where components are assembled. The actual manufacturing costs of at least one component used in multiple product variants are determined. Target costs are calculated per product variant for the component by multiplying the actual manufacturing costs times a coefficient which depends on the mixing ratio of the manufacturing line, i.e., the percentage of product variants in the total number of parts. The actual costs and the target costs are broken down into cost components, i.e., the costs of raw materials, labor costs, processing costs, energy costs, and depreciation. The comparison between actual cost components and target cost components reveals the “adjusting screws” for cost reductions.

DE 10213830 A1 does not describe how the identified cost components and product variants may contribute toward discovering possibilities for technical changes in products or components.

DE 19954609 A1 describes a method for determining and evaluating component variants of a mass-produced product, e.g., a motor vehicle, and displaying the results graphically in a variant tree. In addition, evaluation criteria are defined and used to evaluate the component variants with regard to their quality and importance for the mass-produced product. The component variants shown in the variant tree are evaluated according to these criteria. For example, a component variant will have a high ranking if it is installed in many vehicle variants or in vehicle variants manufactured in large numbers.

The evaluation criteria described in DE 19954609 A1 are based exclusively on the frequency of use of component variants. This document does not describe how the variant tree may be used for cost reduction through technical changes.

US 2002/0143677 A1 describes a system and a method for lowering the costs of supplied components, for example. A user specifies a target for cost reduction and a procedure for generating a target price (baseline price). For example, the user may specify a statistical method, e.g., forming a sliding average. Actual prices for operations in the past (transaction data), e.g., supply of components, are determined. With the help of this procedure, a target price is calculated for each operation and compared with the actual price of the operation. Potential savings are then determined from these comparisons.

EP 1168225 A1 describes a device which estimates the cost of a product, e.g., the manufacturing costs of a motorcycle. With this device it is possible to calculate the manufacturing costs. The calculated costs of manufacturing a component in-house, for example, may be compared with the costs of manufacturing by a supplier. Furthermore, it is possible to predict approximately how changes in “product design,” i.e., in its construction and various manufacturing methods, will affect the costs of the product. This device uses information about the product to be manufactured, e.g., its design, manufacturing costs of components and information about influencing factors, e.g., wage costs, costs of materials. Various experts preferably provide cost estimates. A user will classify manufacturing steps (processes) which are performed to manufacture a motorcycle, for example. With the help of cost tables, the costs for performing manufacturing steps of a category may be estimated.

US 2002/0143677 A1 and EP 1168225 A1 do not describe an approach for relating cost reductions to technical features and possible changes in the components.

The object of the present invention is to create a device and a method by which technical causes for differences, e.g., causes for different costs, may be determined between the same product components in different product types.

This object is achieved through a device as recited in Claim 1 and a method as recited in Claim 11 and Claim 13. Advantageous embodiments are defined by the subclaims.

A calculation for a component is understood to refer to the path and the result of a systematic derivation of a parameter of the component. Examples of such parameters include the following:
the costs of manufacturing the component,
the costs of acquisition of the component,
a machine hourly rate or wage hourly rate in a manufacturing plant having a multitude of different machines and workers,
how long the manufacturing of the component will take,
how much of a material will be required to manufacture the component,
what is the maximum external mechanical load the component will withstand,
the weight of a component as a function of its dimensions, geometry, and densities of the materials used for manufacturing,
the tolerance in shape, position, or dimensions,
scattering of a parameter of a component manufactured in large numbers,
the temperature range in which the component may be used,
occupancy of conveyor belts in a manufacturing plant, production sequence in the manufacturing plant,
design or layout of a manufacturing line,
utilization of capacity of a manufacturing line or
rejects expected in production of a component.

The derivation of the parameter depends on technical features of the component, e.g., dimensions and/or the manufacturing process to manufacture the component. In the case when the calculation is based on costs, it will preferably take into account different types of costs, e.g., the costs of materials, the costs of using machines, and the overhead. A calculation processor such as that known from EP 1168225 A1 may be used to perform a calculation.

The device according to the present invention is implemented on the basis of a data processing system. It includes an electronic listing of product types, e.g., motor vehicle model series of different automotive manufacturers and different variants of the model series. In the case of motor vehicles, the term product type is understood to refer to a model series or a variant of a model series. Use of electronic listing ensures that no product type will be taken into account multiple times, e.g., under various names.

The device also includes an electronic parts list for each product type. This parts list describes an imaginary breakdown of a product of that product type into its components. The product is analyzed functionally here and the parts list includes all components of the product. Use of this generic parts list which is thus valid for all product types ensures that a component will be provided with the same name in each calculation, and the same components of a product are identified, regardless of which product type a calculation for a given component is based on. Thus components and calculations are comparable. This avoids, for example, having a calculation for the component “drive” based only on the engine in one calculation but based on the complete drive train in another calculation. In addition, the generic parts list defines features for the components. This definition is also valid for each product type and ensures that the same feature is always identified in the same way and has the same meaning.

The device also includes an electronic description database having automatically analyzable descriptions for each component occurring in the parts list. Each description of a component is based on a component in the parts list and a product type occurring in the list. The description defines characteristics, i.e., values or value ranges of features of the component in this product type. The generic parts list determines which features the component has. However, the product types may be differentiated through different characteristics, i.e., values or value ranges of the features of the same component. For example, different motor vehicles differ through different values of the feature “displacement” of the “engine” component.

The device also includes an electronic calculation database and the corresponding calculations. Each of these calculations is based on a component occurring in the parts list and a product type occurring in the list. Since the calculations are based on one entry each in the list and the parts list, they are comparable to one another.

The term “database” here refers to any type of permanent or temporary data storage, e.g., a hierarchical, relational, object-oriented or object-relational database, a set of XML files, a file management system having data files, or an unstructured data filing system associated with a semantic network, and a search engine. A combination of different data filing systems is also possible. Data stored in the database may be stored in a permanent memory of a data processing system, for example, or a portable data memory medium, e.g., a CD-ROM.

The device also includes a unit for selecting at least one component occurring in the parts list and a means for automatic determination of all calculations related to a selected component. After a component has been selected from the parts list using this selector mechanism, the determination device automatically determines all calculations related to the selected component.

The device also has a unit for generating a comparison of the results of the calculations thus performed. This comparison shows all the results of the performed calculations which are based on a previously selected component as well as the descriptions of this component in the particular product types. For example, if the “engine” component is selected, the determination device will perform all the calculations based on a given engine. A_1, . . . , A_5 denote the five types of motor vehicles on which these engine calculations are based. The comparison includes these five calculations as well as the five descriptions of the engine in five vehicle types A_1, . . . , A_5.

Through this device and method, all calculations based on a previously selected product component are found and compared automatically, quickly, and without error.

Since the calculations of a comparison are based on the same product component, they are mutually comparable. This makes the differences between the same product component in the different product types transparent and traceable. Since the comparison includes technical descriptions of the component in the particular product types, the comparison facilitates a discovery of technical differences of the component in the product types resulting in different results in the particular calculation. This makes it possible to identify certain product types in which the component is associated with particularly high costs, high weight, or low availability, for example. The variants in the component in these product types are thus the causative factors in the different results. The comparison with their descriptions of the component links the results of the calculations with technical contents and properties of the components taken into account in the comparison. The comparison supplies the technical causes of different results of the calculations and provides “adjusting screws” for technical changes in the component, e.g., design changes in the component or changes in the process for manufacturing the component.

Since the calculations are based on components in a parts list that is in effect for all product types, the calculations have the same structure, which facilitates comparison and increases transparency. The device allows a manufacturer of motor vehicles, for example, to compare the components of his vehicles with one another and with those of competing vehicle manufacturers, e.g., with regard to acquisition costs or weight. It is also possible to compare a vehicle that has so far only been designed or even just roughly drafted, but has not yet been manufactured, with vehicles available on the market, and to discover approaches for technical improvements which result in lower costs or better availability. The comparison may therefore be performed at an early stage in product development.

In the embodiment as recited in Claim 2, not only the product but also the product components occurring in the generic parts list are to be broken down. The parts list additionally includes an imaginary breakdown of each component into individual parts. This breakdown applies to all product types. At least one calculation in the calculation database includes information about the percentage of each part of the component on which the calculation is based on the result of the calculation. This information thus supplies a breakdown of the results of the calculation into the parts of the component to which the calculation relates. The comparison-generating device is able to generate a partial comparison for each part of the selected component. The partial comparison for each part shows the percentage each part has on the results of the calculations of the comparison. For example, the partial comparison shows the contributions of the parts to the results of the calculations. The comparison thus generated is preferably constructed in such a way that it includes all partial comparisons for the parts of the selected component.

Since the breakdown of the component into parts is applicable to all product types, the contributions of the parts to the results of the calculations are mutually comparable. In particular the following are comparable:
Contributions of one part to calculations for the component in various product types and
Contributions of different parts to the calculation for a component in one product type.

Parts of the component that make a high contribution to the result of the calculation in certain product types are identifiable with the help of this comparison. If the calculations are based on cost, the components in these product types are thus the cost-driving factors. The descriptions of the component supply the technical features of these cost-driving factors and are thus the “adjusting screws” for technical changes in the component.

In the refinement as recited in Claim 3, the generic parts list for each part includes at least one feature. This breakdown is valid for all product types. In addition, each component description in the component database includes the characteristics, i.e., the values or value ranges of the parts of the component in the particular product type. The comparison thus generated additionally includes the characteristics of the features of the parts of the selected component in the product types on which the calculations are based. Therefore, in addition to the calculations, the comparison shows the different configurations of the component in the product types. Each calculation for a component also includes the costs of the parts of the component.

In Claim 5, the calculations are related to costs, e.g., the manufacturing costs of components of the product types. The costs are composed of different cost types. The device includes an electronic list having the possible cost types of a calculation, this cost type list being in effect for all components of the parts list and all product types of the list. Therefore, the cost calculations are composed exclusively of cost types from this list. The calculation in the calculation database includes a partial calculation for each cost type from the cost type list. It is possible that individual cost types in a calculation might not contribute anything to the result of the calculation, i.e., to the total costs. The comparison-generating unit includes means for breaking down a comparison that is generated into the cost types of the cost type list. This makes it possible for the comparison to differentiate the components in the product types with regard to various cost types and to determine technical causes for cost differences with regard to a certain cost type, for example.

In a refinement of this embodiment, the device generates a comparison of cost calculations in which not all cost types but instead only certain previously selected cost types of the cost type list occur (Claim 6). The cost types not selected are automatically removed from the comparison.

In another refinement (Claim 7), the device makes it possible to generate an optimum calculation composed of partial calculations of the comparison. The device includes a unit which makes it possible to select a calculation contained in the comparison for each cost type of the cost type list. If, for example, the cost type list is made up of three different cost types, then each calculation in the comparison is made up of three partial calculations. The device makes it possible to select a first calculation for the first cost type, a second calculation for the second cost type, and a third calculation for the third cost type. The same calculation may be selected for different cost types. The selection is made, for example, by selecting the product type on which the calculation is based in each case.

The device generates an optimum calculation made up of a partial calculation per cost type of the cost type list. The partial calculation of this optimal calculation based on cost type K_x is equal to the partial calculation for cost type K_x in the particular calculation of the comparison selected for cost type K_x.

An exemplary embodiment of the present invention is described below in greater detail on the basis of the accompanying drawing.

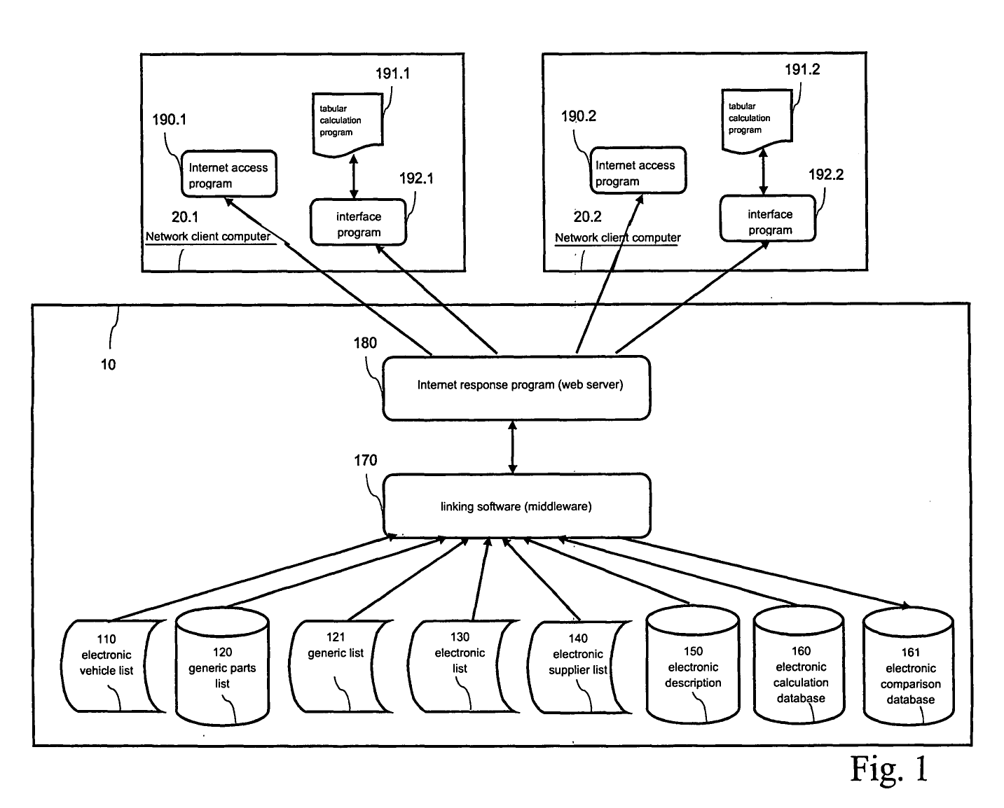

FIG. 1 shows an architecture of the device according to the present invention;

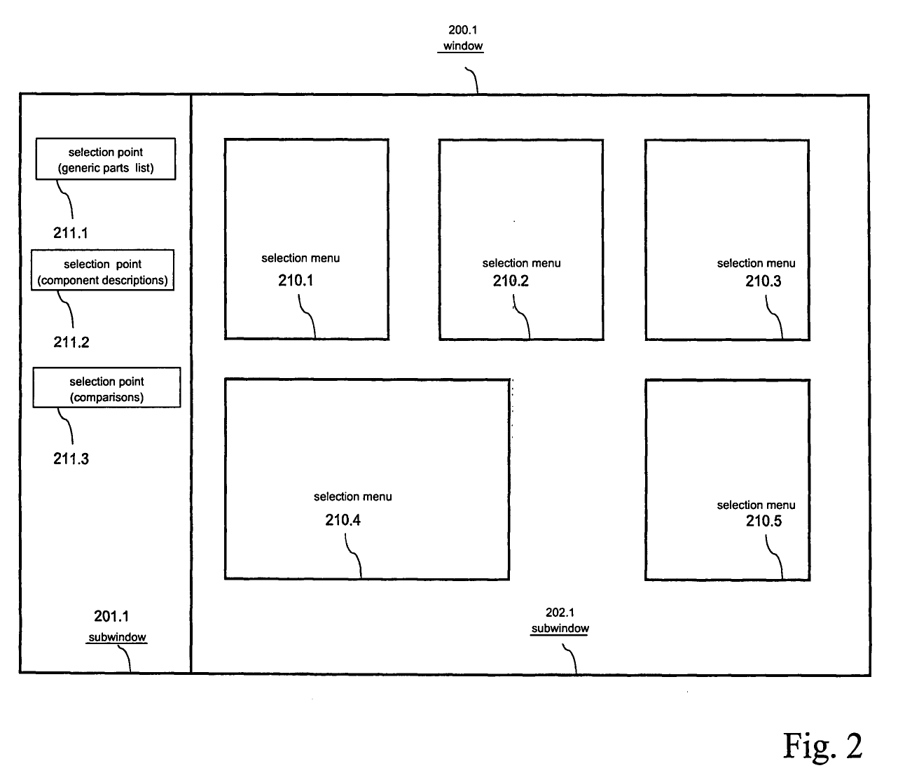

FIG. 2 shows the device for selecting a product component;

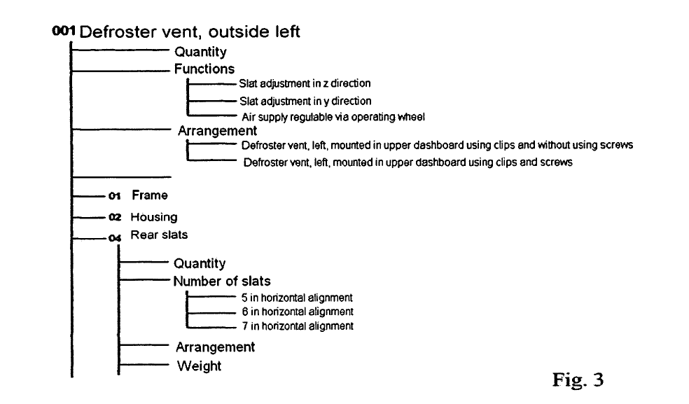

FIG. 3 shows a tree-like diagram of the information about a main part;

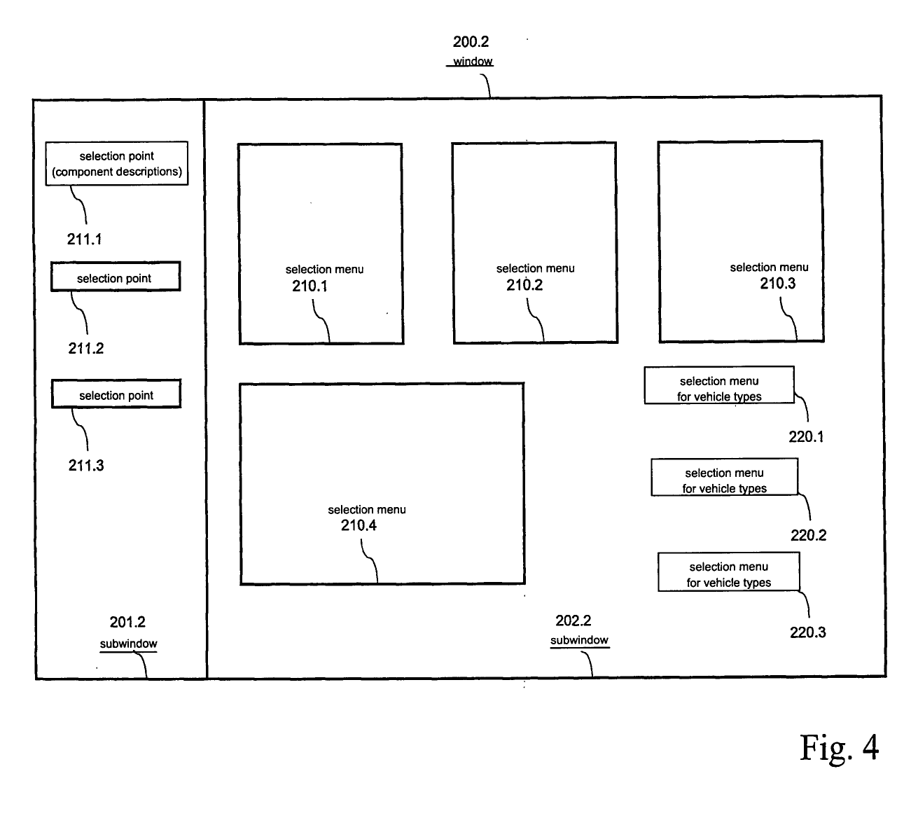

FIG. 4 shows a window for selecting a component and vehicle types;

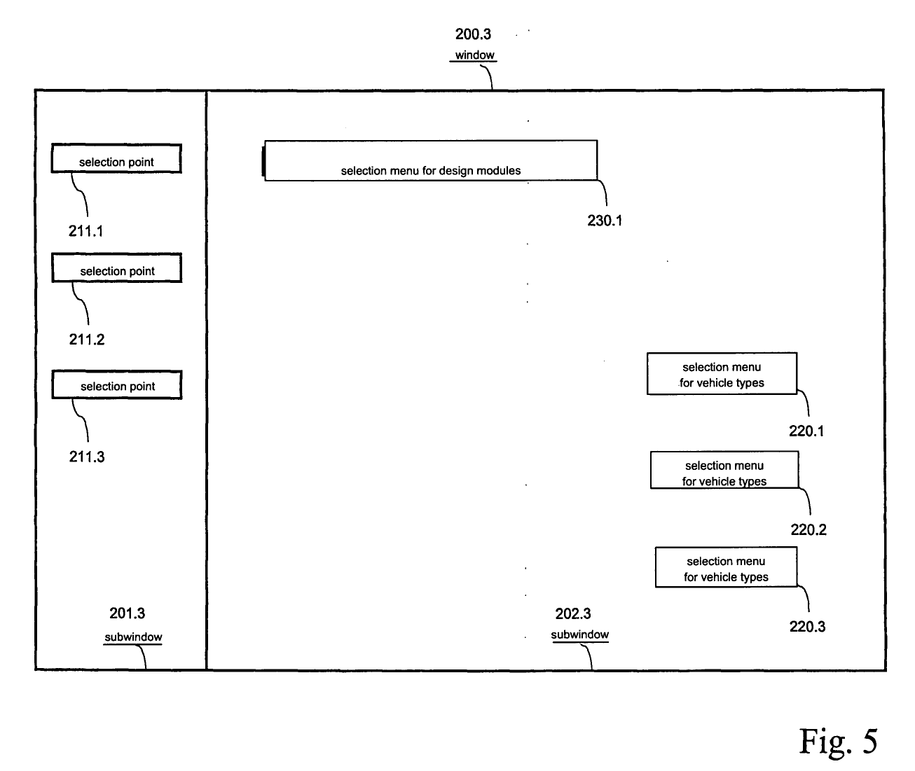

FIG. 5 shows a window for selecting a design module and one to three vehicle types;

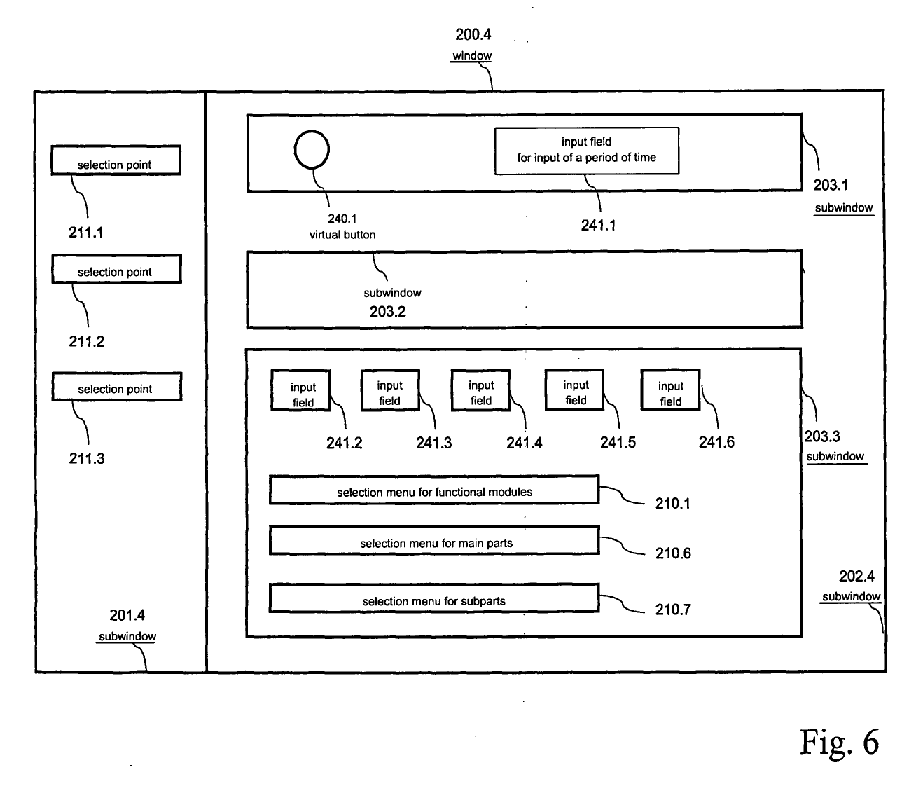

FIG. 6 shows a window for selecting a new comparison in the second step in the specification of a new comparison;

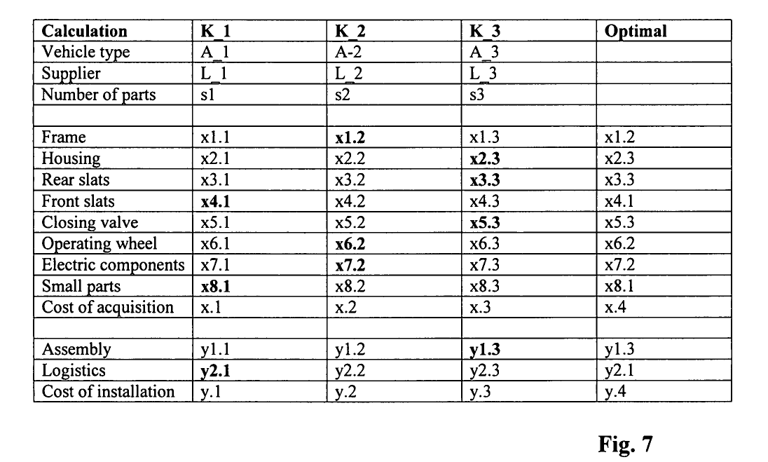

FIG. 7 shows a tabulated comparison of a breakdown according to components;

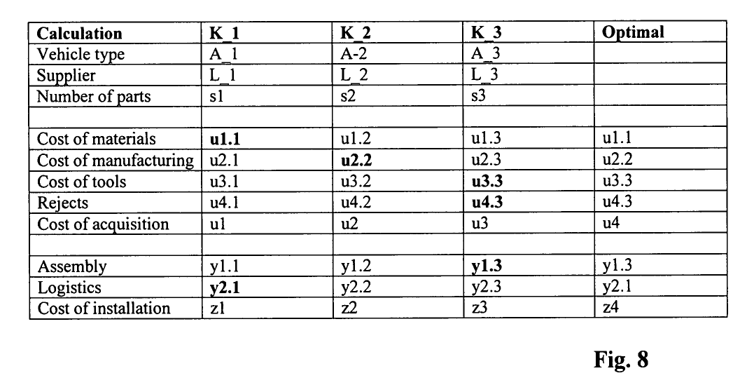

FIG. 8 shows a tabulated comparison of a breakdown according to cost types.

The exemplary embodiment is based on components of motor vehicles. The device according to the present invention is used by a manufacturer of motor vehicles. A product type in this exemplary embodiment is a type of vehicle. For illustration purposes, “vehicle type” is used below instead of “product type.” A vehicle type is preferably characterized by the following determinations:
identification of the vehicle type,
the manufacturer of the vehicle type,
the model series,
the type of engine (e.g., diesel or gasoline engine and the number of cylinders and displacement) and
a certain model year.

The device according to the present invention is implemented with the help of a central computer (server) 10 of a network and multiple subscriber computers (clients) 20.1, 20.2 of the network. Network client computers 20.1, 20.2 are connected by an intranet to the central computer of the network. The architecture of the device includes the following three layers:
the data holding layer for data holding,
the application layer for executing the analyses and generating the comparisons, and
the display layer for displaying the comparisons generated.

FIG. 1 shows an exemplary architecture of the device according to the present invention. In this example, the central computer of the network is connected to two network client computers 20.1, 20.2. The arrows in FIG. 1 represent data flows.

The following databases and software programs are installed on network server 10:
an electronic vehicle list 110 listing all vehicle types taken into account, the vehicle types preferably originating from different vehicle manufacturers,
a generic parts list 120, i.e., an electronic parts list valid for each vehicle type, describing a breakdown of a motor vehicle into its components and defining at least one feature for each component. Generic parts list 120 also includes an electronic characteristics list for each feature which defines the possible characteristics of the feature,
a generic list 121 having the standard configurations of design modules in effect for all vehicle types for which no different specifications have been defined,
an electronic list 130 having cost types in effect for all calculations,
an electronic supplier list 140 including the suppliers supplying at least one product component for at least one vehicle type or being considered at least for the delivery,
an electronic description database 150 having automatically analyzable descriptions. Each of these descriptions is based on a component occurring in generic parts list 120, each component description being in effect for at least one vehicle type occurring in vehicle list 110. Each description includes a reference to a component in generic parts list 120 and at least one reference to a vehicle type in vehicle list 110. The description defines a characteristic that is in effect for the type of vehicle from the list of characteristics of this feature and does so for each feature defined for the component in the generic parts list 120. A description in description database 150 thus includes a list of features of the component and the characteristics of these features in effect for the vehicle type,
an electronic calculation database 160 having calculations based on a component occurring in parts list 120 and a vehicle type occurring in the list,
an electronic comparison database 161 having automatically analyzable specifications for generating a comparison,
an Internet response program (web server) 180 that receives requests and inquiries from a network client computer 20.1 or 20.2, e.g., via the HTTP protocol, and forwards the answers and responses generated by network server 10 to the inquiring network client computer,
linking software (middleware) 170 for linking databases 150, 160, 161 and electronic lists 110, 120, 130, 140 to Internet response program 180.

An Internet response program 180 is understood to be a program on network server 10 which transmits Internet pages (web pages) to inquiring network client computers 20.1, 20.2. An inquiring network client computer 20.1, 20.2 must first transmit a request to Internet response program 180 via an Internet address specific to Internet response program 180, e.g., by selecting certain alternatives in a web page displayed by Internet access program 190.1, 190.2. The address is in the form of a “Uniform Resource Identifier” (URI). The structuring of a URI is described at http://www.w3.org/Addressing/, as queried on Jan. 8, 2003. The web page may be either static or dynamic. A dynamic web page is generated by Internet response program 180. To do so, Internet response program 180 sends queries to one of the databases and uses the replies to generate the web page.

Linking software 170 allows one database to be replaced by another without having to change the rest of the equipment.

The following software programs are installed on each network client computer 20.1, 20.2:
an Internet access program (web browser) 190.1, 190.2 capable of sending inquiries to network server 10 and displaying a web page transmitted by network server 10,
a tabular calculation program 191.1, 191.2 that generates comparisons in tabular and graphic form and
an interface program 192.1, 192.2 that functions as an information relaying interface between the programs and databases on network server 10 and tabular calculation program 191.1, 191.2 on this network client computer 20.1, 20.2.

The components of the device according to the present invention stored on network client computers 20.1, 20.2 belong to the display level.

The following features are stored for each vehicle type in vehicle list 110:
an identification of the vehicle type,
a characteristic of the engine of the vehicle type,
the fuel consumption of a vehicle of this vehicle type,
the empty weight of a vehicle of this vehicle type.

In addition, the vehicle types are classified preferably according to different vehicle segments. This classification is also stored in vehicle list 110. Examples of vehicle segments include “upper class sedan,” “middle class sedan,” “compact sedan,” “off-road vehicle,” “sports car,” and “utility vehicle.”

Generic parts list 120 forms an imaginary functional breakdown of a vehicle into its components. It is complete, i.e., it includes all components. In a preferred embodiment, it includes the following six levels of detail:
overall vehicle,
function modules,
partial systems,
subsystems,
main parts and
subparts.

The “product components” in this embodiment include the function modules, the partial systems, the subsystems, the main parts, and the subparts of a vehicle. The overall vehicle is made up of a plurality of function modules, a function module of multiple subsystems, a subsystem of multiple subsystems, and so forth.

Examples of function modules:
passenger compartment—body-in-white,
doors,
cockpit,
front axle and
rear axle.

The “cockpit” function module is broken down functionally in generic parts list 120 to yield the following subsystems:
dashboard,
center console,
air conditioning/heating system and
crossbeam.

The “dashboard” partial system is functionally broken down into the following subsystems in generic parts list 120:
dashboard, above,
dashboard, lower right with glove compartment,
dashboard, lower left,
paneling, jacketed pipe,
trim/visors,
vents, dashboard, and center console,
instruments and displays in the cockpit and
conductor set.

The “vents, dashboard, and center console” subsystem is broken down into the following main parts in generic parts list 120:
defroster vent, outside left,
defroster vent, outside right,
vent, outside left,
vent, outside right,
vent, center,
vent, rear center,
vent, knee guard,
mounting device for defroster vent, outside left,
mounting device for defroster vent, outside right and
mounting device for vent, knee guard

The “defroster vent, outside left ” main part is broken down into the following subparts in generic parts list 120:
frame,
housing,
rear slats,
front slats,
closing flap,
operating wheel,
electric components and
small parts.

Each product component is characterized by a sequence of numerals. The function modules are characterized by two numerals and the “cockpit” function module is characterized by the number “10.” The subsystems are characterized by four numerals, the first two numerals of which are those of the higher level main system. The “dashboard” subsystem in the “cockpit” function module is characterized by the sequence “10 10.” The subsystems are characterized by six numerals, the first four numerals of which are those of the higher level partial system. The “vents, dashboard, and center console” subsystem in the “dashboard” partial system is characterized by the sequence “10 10 60.” The main parts are characterized by nine digits, the first six digits of which are those of the higher level subsystem. The “defroster vent, outside left” main part in the “vents, dashboard, and center console” subsystem is characterized by the sequence “10 10 60 001.”

The following features are defined for the “defroster vent, outside left” main part in generic parts list 120:
number (of the defroster vents on the outside left in the “vents, dashboards, and center consoles” subsystem),
functions,
arrangement, i.e., the type of mounting,
number of lights,
design,
manufacturing method,
area (in mm²),
functions performed,
weight (in kg),
supplier and
brief description.

For each of these features, a list of characteristics is defined, i.e., a list of possible characteristics of the feature. For example, the following possible characteristics have been defined for the feature “arrangement”:
defroster vent, left, mounted in the upper dashboard using clips and without using screws,
defroster vent, left, mounted in the upper dashboard using clips and screws.

The following possible characteristics have been defined for the feature “functions”:
slat adjustment in z direction,
slat adjustment in y direction,
air supply regulatable via operating wheel.

The following possible characteristics are defined in generic parts list 120 for the “design” feature:
roller vent,
slat vent,
round vent,
closed slats,
ball vent.

Features are also defined for the subparts of this main part. For example, the following features are defined for the “rear slats” subpart:
number (of rear slats on the outside left in the “defroster vent, outside left” main part),
number of slats (in a rear slat),
arrangement, i.e., the type of mounting,
weight (in kg),
material,
surface,
surface feel,
suppliers,
brief description and
manufacturing method.

For the “number” feature of the “rear slat” subpart, the following possible characteristics are defined:
5 in horizontal alignment,
6 in horizontal alignment,
7 in horizontal alignment.

For the “surface feel” feature of the “rear slats” subpart, the following possible characteristics are defined:
hard,
soft,
smooth,
nonskid.

The possible cost types into which a calculation may be broken down are listed in electronic list 130 for cost types. Calculation in calculation database 160 is broken down into all or at least some of these cost types. The following cost types are differentiated in cost type list 130:
cost of materials,
manufacturing costs,
overhead,
profits,
other cost types.

Subcost types are defined for these cost types. Some of these subcost types are mutually exclusive while others are complementary. There are the following subcost types for the cost of materials:
individual cost of materials for materials purchased by the supplier of the particular component,
materials overhead,
cost of accessory parts by the supplier for manufacture of the particular component,
cost of materials minus rebates.

There are the following subcost types for the manufacturing costs:
machine costs,
personnel costs.

For overhead there are the following subcost types:
startup costs of mass production,
costs for rejects of the supplier,
costs for rejects of the subcontractors,
costs for development of the component,
management and distribution costs,
cost of tools,
cost for manufacturing plants,
overhead for logistics of the vehicle manufacturer.

For the profits, there are the following subcost types:
profit on materials,
profit on manufacturing.

For the other cost types there are the following subcost types:
assembly costs of the vehicle manufacturer.

In addition, derived cost types and automatically analyzable computation rules for the cost types are stored in cost type list 130, i.e., how cost types are calculated from other cost types. The following computation rule is stored, for example:
acquisition costs=manufacturing costs+cost of materials
construction costs=acquisition costs+assembly costs+logistics costs

An example of an automatically analyzable description in electronic description database 150 is given below. This description is based on vehicle type A_1 as the product type and on the “defroster vent, outside left” main part as the product component. The description defines the following, among others:
type of mounting: defroster vent, left, mounted in upper dashboard using clips,
number of lights: 0
design: slats not adjustable,
manufacturing method: injection molded PBT/PC GF30
weight (kg): 0.010

Such a description is automatically executable. In particular, an analyzable program on network server 10 is capable of automatically identifying each subpart, each feature, and each characteristic in the description without any doubt. This is achieved using a structured data filing system. For example, filing may be performed using the “Extensible Markup Language” (XML) data format. A description of XML is given at http:/www.w3.org/xml, inquiry made on Jan. 8, 2003.

Technical descriptions are preferably stored in a feature of the product component intended for this purpose. For example, the following definition is given for a main part in a vehicle type A: the hinge must continuously withstand a load of 40 kg. The definition for the same main part in a vehicle type B is: the hinge must briefly withstand a load of 20 kg. These product descriptions facilitate a comparison of different calculations.

Cost calculations are stored in electronic calculation database 160. Each calculation includes a traceable path and the result of a systematic derivation of the acquisition costs achieved in this way, i.e., acquisition costs that must be paid by an automobile manufacturer for a certain component of a vehicle. Each calculation has the following attributes which function as specifications for the calculation:
the product component on which the calculation is based, where the attribute value is in the form of a reference to a component in generic parts list 120,
at least one vehicle type included in vehicle list 110,
a supplier included in supplier list 140, the calculation being based on the cost of acquisition of the product component from this supplier,
the number of units of the component on which the calculation is based, e.g., 40,000 units if components for 10,000 vehicles of one type are needed and each vehicle has four of these components,
the date or period of time on or in which the calculation is valid,
the type of calculation,
at least one manufacturing method used in manufacturing the product component,
at least one material used in the manufacture of the product component according to the calculation,
at least one resource used in the manufacture of the product component,
a region or a site in which this component is manufactured, e.g., a nation or a federal state, where the calculation is based on manufacture in this region or at this site,
administrative information about the calculation, e.g., the name of an employee of the vehicle manufacturer.

The following types of a cost calculation are differentiated:
a bid by a supplier,
a guideline price calculation,
an estimate by the vehicle manufacturer,
a negotiation result,
a target price calculation of the vehicle manufacturer as a specification to suppliers.

The guideline price calculation yields a detailed derivation of the cost of a component, where manufacturing times, input factors, and/or other parameters of the component are taken into account and, for example, specifications, design drawings, or prototypes of the component are used. The transaction result specifies the price per component at which a supplier supplies a certain amount of the component to the vehicle manufacturer.

It is possible that various components are manufactured with different manufacturing methods and/or from different materials and therefore different manufacturing methods and/or materials are specified in a calculation. The materials include the materials of which the component is manufactured as well as the auxiliary materials and process materials consumed during manufacturing without being included in the finished component.

Examples of resources include manufacturing lines, machine tools, chucking devices, and workers that are needed for a certain period of time for manufacture of a component.

With the help of web browser 190.1, 190.2 on a network client computer 20.1, 20.2 and web pages displayed by the latter, the following components of the device are implemented:
the unit for selecting at least one vehicle type occurring in vehicle list 110,
the unit for selecting at least one component occurring in generic parts list 120,
the unit for selecting at least one cost type occurring in cost type list 130,
a unit for selecting a calculation for each cost type of cost type list 130 included in the comparison.

A user of a network client computer 20.1 uses the device according to the present invention to generate comparisons. He first calls up a web browser 190.1 and enters into the browser the Internet address of Internet response program 180 stored on network server 10. Internet response program 180 generates a response in the form of an HTML document which web browser 190.1 displays on the display screen of network client computer 20.1. The HTML document is used as a start window. The user enters a user identification and a password and then has access to the functionalities of the device described below. Since any user who knows the address of Internet response program 180 and uses a network client computer 20.1 having web browser 190.1 is able to call up the start window, protection against unauthorized use is necessary. The situation is similar for a user of network client computer 20.2 having web browser 190.2.

The functionalities of the device according to the present invention may be broken down into three groups:
generating and displaying details of generic parts list 120,
generating and displaying component descriptions,
generating and displaying comparisons.

The functionalities of these three groups may be called up by selecting one of three items: selection points 211.1 (generic parts list), 211.2 (component descriptions), and 211.3 (comparisons).

FIG. 2 shows as an example the unit for selecting at least one component occurring in generic parts list 120. Web browser 190.1 on client computer 20.1 generates a window 200.1 on the display screen after selecting selection point 211.1 of a network client computer 20.1. This window is broken down into two subwindows 201.1 and 201.2. In left subwindow 201.1, a user selects the next action. Therefore, left subwindow 201.1 includes all three selection points 211.1, 211.2, and 211.3.

Right subwindow 201.2 also includes three permanently displayed selection menus 210.1, 210.2, and 210.3. In selection menu 210.1, the function modules of generic parts list 120 are displayed. Each function module here is represented by its two characterizing digits and its name, e.g., “10 cockpit.” As soon as a user has selected one of these function modules, the partial systems of this function module are displayed in selection menu 210.2. After selecting the cockpit function module, the “dashboard” through “crossbeam” partial systems listed above are listed. Each partial system here is represented by the last two characterizing digits and its name, e.g., “10 dashboard.” As soon as a user has selected one of these partial systems, the subsystems of this partial system are displayed in selection menu 210.3. After selecting the “dashboard” subsystem shown in selection menu 210.2, the “dashboard above” through “conductor set” subsystems are shown in selection menu 210.3, each being characterized by its last two digits, e.g., “60 vents, dashboard, and center console.” After selecting the “vents, dashboard, and center console” subsystem, a fourth selection menu 210.4 is generated and listed, displaying the main parts of the “vent, dashboard, and center console” subsystem contained in generic parts list 120, i.e., the main parts “defroster vent, outside left” through “mounting device for the knee guard vent.”

In the listing of main parts, a pictogram, e.g., an arrow pointing to the right, is shown at the left next to each main part. As soon as the user clicks on the right-pointing arrow, located at the left next to the main part “defroster vent, outside left,” the subparts of this main part, i.e., subparts “frame” through “small parts,” are displayed. These subparts are displayed not in another selection menu but instead in selection menu 210.4 between the main part “defroster vent, outside left” and the main part “defroster vent, outside right” which follows in the listing. This embodiment makes another main menu unnecessary. As soon as the user clicks on and thereby selects a main part or a subpart shown in selection menu 210.4, its features defined in generic parts list 120 are displayed, namely in another selection menu 210.5. After selecting the main part “defroster vent, outside left,” the features “quantity” through “brief description” of the main part “defroster vent, outside left” are displayed in selection menu 210.5. After selecting the subpart “rear slats,” the features “quantity” through “manufacturing method” of the subpart “rear slats” are displayed in selection menu 210.5. After selecting a feature shown in selection menu 210.5, its possible characteristics, i.e., the characteristics list, of this feature contained in generic parts list 120 are shown. The characteristics list is preferably also shown in selection menu 210.5. After selecting the feature “surface feel” of subpart “rear slats,” the possible characteristics “hard” to “non-skid” are displayed. In the embodiment just described, window 200.1 having selection menus 210.1 through 210.5 belongs to the unit for selecting at least one product component occurring in generic parts list 120.

After the user has selected a main part, for example, and has clicked on a selection point (not shown in the figures), a user-friendly tree-like display of information about the main part contained in generic parts list 120 is generated. As an example, FIG. 3 shows a detail of this display for the main part “defroster vent, outside left.”

This tree-like display has as its root the name of the main part. The features of the main part “defroster vent, outside left,” for example, as well as its subparts are shown as the successors of the root. A user may select a subpart or feature that is shown and include or exclude the following information.

For a product component, it may be noted in generic parts list 120 that it is optimal. This product component is then not necessarily present in each vehicle but instead is available in only a few types of vehicles. The “navigation system” is a subsystem that is an example of an optimal product component—only a few vehicle types are offered with a navigation system.

The functionalities described here belong to the group “generate and display details from generic parts list 120.” Functionalities belonging to the group “generate and display component descriptions” will be described next.

After selecting selection point 211.2 (“component descriptions”), the functionalities of the group “generate and display component descriptions” may be retrieved. FIG. 4 shows a window 200.2 for selecting a component and vehicle types. Left subwindow 201.2 in turn includes three selection points 211.1, 211.2, and 211.3. Right subwindow 202.2 includes selection menus 210.1 through 210.4 described above as well as three other selection menus 220.1, 220.2, and 220.3 for vehicle types.

A user selects a main part as described above, e.g., the main part “defroster vent, outside left.” In addition, he selects one to three vehicle types with the help of three selection menus 220.1, 220.2, and 220.3. For the following example, the user selects three types A_1, A_2, and A_3. After these selection operations, a comparison of three component descriptions for the main part “defroster vent, outside left” in three vehicles types A_1, A_2, and A_3 are generated. This comparison is preferably in the form of a table. This table has four columns, namely one column for the identifications of subparts of the selected main part and their features and one column each for three vehicle types A_1, A_2, and A_3. The table has one line per subpart and also one line per feature of the main part and one line per feature of each subpart. The characteristics of the particular feature in the particular vehicle type are automatically entered into the fields of the table. For example, the field in the column for vehicle type A_1 and the feature “manufacturing method” of the main part in the table have the entry “injection molded PBT/PC GF30.” The field in the column for vehicle type A_2 and the feature “surface feel” of the subpart “rear slats” have the entry “hard,” for example.

This comparison is generated by Internet response program 180 through reading access to generic parts list 120 and electronic description database 150. The program obtains from generic parts list 120 and description database 150 the features of the main part, the subparts, and the characteristics of these features for three vehicle types A_1, A_2, and A_3. Because of the structured data filing, the analysis is performed rapidly and without error, which would be impossible with unstructured data filing in plain text.

As explained above, generic parts list 120 includes an imaginary breakdown of a vehicle into its functional components. For the manufacture of a vehicle, complete design modules are often preassembled and pretested and only then delivered to the manufacturing line for the vehicle. Which main parts are included in such a design module is often defined as a function of manufacturing factors, e.g., good installability. A design module may therefore contain main parts belonging to different function modules of generic parts list 120.

A standard configuration of the design module is preferably defined, i.e., a listing of the main parts of generic parts list 120 belonging to the design module. This standard configuration is in effect for all vehicle types for which nothing else has been specified. A deviating configuration of the design module may be specified for a vehicle type. A design module may thus be configured differently in different vehicle types.

On request by the user, the device according to the present invention generates a comparison of the configuration of design modules in different vehicle types. FIG. 5 shows a window 200.3 having two subwindows 201.3 and 202.3 for selecting a design module and one to three vehicle types. Right subwindow 202.3 includes selection menus 220.1, 220.2, and 220.3 described above for selecting as many as three vehicle types and another selection menu 230.1 for design modules.

Examples of design modules displayed in selection menu 230.1 include the “cockpit module,” not to be confused with the “cockpit” function module, the front module, the roof module, and the door module. After selecting the design module “cockpit module” and vehicle types A_1, A_2, and A_3, a comparison is generated, including three columns for three selected vehicle types A_1, A_2, and A_3. The column for A_1 lists the main parts making up the “cockpit module” design module in vehicle type A_1. For example, these may be the following main parts which belong to the “cockpit module” design module and to various function modules:
driver airbag,
vent, outside left,
vent, outside right,
vent, center,
passenger airbag restraint system,
contact spiral,
headlight switch,
dashboard assembly, upper.

In vehicle type A2, the following main parts belong to the “cockpit module” design module:
vent, outside left,
vent, outside right,
vent, center,
headlight switch.

In vehicle type A3, the following main parts belong to the “cockpit module” design module:
driver airbag,
vent, outside left,
vent, outside right,
vent, center,
passenger airbag restraint system,
contact spiral,
headlight switch.

On request, a detailed display is generated. This display shows not only the main parts making up the selected design module in the particular vehicle type but also the features of all main parts and their subparts as well as the characteristics of all these features in vehicle types A_1, A_2, and A_3.

In addition, a comparison of calculations of a design module in various vehicle types is generated. Each calculation is related to a vehicle type.

On request, a comparison permitting a comparison of the following two alternatives is also generated:
The design module is completely preassembled and delivered to the particular vehicle manufacturer.
The main parts of the design module are manufactured separately and delivered to the particular vehicle manufacturer who then installs the main parts in the vehicle.

The comparison shows which main parts of the design module contribute in which percentages to the cost of manufacturing the design module. In addition, it provides a comparison of the different vehicle types. The comparison here permits a decision between the two alternatives mentioned above for certain vehicle types. In addition, it makes it possible to find an optimal configuration for a design module in a vehicle type, for example.

The functionalities of the group “generate and display comparisons” are described below. These functionalities may be broken down into the following subgroups:
generate and display new comparisons for a component,
generate and display new comparisons for an attribute of the calculations,
display existing comparisons.

Selection point 211.3 has multiple subselection points accordingly, which are displayed after clicking on selection 211.3.

The following description first explains how a new comparison for a component is generated and displayed. In the first step, the user specifies the desired type of comparison. The user first selects only one product component or a product component plus a supplier. In addition, the user defines whether the comparison is to relate to
one period of time and multiple vehicle types or
one vehicle type and multiple periods of time.
   For example, this describes as an example the sequence executed after the user has specified that he will preselect a product component and also a supplier, and the comparison to be generated is to be related to one period of time and multiple vehicle types.

In the second step, the user specifies that the comparison should contain the most recent calculations. As an alternative, the user may also specify a fixed period of time, e.g., the year 2002. The user also specifies in the second step to which breakdown level the comparison is to be related. The alternatives “subsystems,” “main parts,” “subparts,” and “all breakdown levels” are available here. Furthermore, in the second step the user selects a product component from the previously selected breakdown level, e.g., the main part “defroster vent, outside left.”

FIG. 6 shows as an example window 200.4 for the selection operations in the second step. Right subwindow 202.4 includes three subwindows 203.1, 203.2, and 203.3. Subwindow 203.1 includes a virtual button 240.1 for establishing that the most up-to-date status should be selected and an input field 241.1 for input of a period of time. Subwindow 203.2 includes a selection menu (not shown) for selecting a breakdown level. Subwindow 203.3 is for selecting a product component of the breakdown level selected in subwindow 203.2. One possibility is for subwindow 203.3 to be designed as described above and as illustrated in FIG. 2 and FIG. 4, i.e., with selection menus 210.1 through 210.4. FIG. 6, however, shows an alternative embodiment. The user selects a component either by inputting its ID digits or by selection with the help of selection menus. Subwindow 203.3 has five input fields 241.2 through 241.6 for this purpose and five selection menus for function modules, partial systems, subsystems, main parts, and subparts, of which FIG. 6 shows selection menu 210.1 for function modules and two selection menus 210.6 for main parts and 210.7 for subparts. To select the main part “defroster vent, outside left,” the user enters either the digits “10” into input field 241.2, “10” into input field 241.3, “60” into input field 241.4, and “001” into input field 241.4. Or the user selects function module “cockpit” in selection menu 210.1, then selects the “dashboard” partial system in selection system 210.2, then selects the subsystem “vents, dashboard, and center console,” and finally selects the main part “defroster vent, outside left” in selection menu 210.6.

In the third step, the user may limit the search for calculations by specifying certain attribute values for some attributes of the calculations. It is also possible for the user not to specify any restrictions. For the following attributes, the user may specify restrictions in the third step:
the vehicle segment to which the vehicle types belong and to which the calculations of the comparison to be generated are related,
the vehicle type,
the supplier,
the type of calculation,
the region or site.

After the search for calculations has been specified in the third conclusion, Internet response program 180 searches for calculations corresponding to the requirements of the specification. For example, the user has specified in the second step that the most current status is to be selected, the main part “defroster vent, outside left” is selected, and in the third step “upper class sedan” is specified as the vehicle segment. All calculations related to the main part “defroster vent, outside left” in vehicle types of the vehicle segment “upper class sedan” and not replaced by a more current calculation are then determined.

First, a brief comparison of the results of the calculations determined is generated. This brief comparison shows the following for each calculation:
the vehicle type,
the supplier,
and the type of calculation.

The user selects all or only at least one of the calculations so determined. In the example described below, the user selects three calculations K_1, K_2, K_3 from the five calculations determined. He assigns a name for the comparison to be generated and optionally writes a brief description of the comparison.

In addition, the user selects which cost types are to be taken into account in the comparison. He may specify that all cost types are to be taken into account or he may select at least one cost type from cost type list 130. In addition, the user specifies subcost types for the selected cost types. The device according to the present invention ensures that the user cannot select two mutually exclusive subcost types.

The comparison is preferably generated in the form of a binary data file by Internet response program 180, transmitted to inquiring network client computer 20.1, and displayed with the help of table calculation program 191.1 installed there. Internet response program 180 here accesses calculation database 160 via linking software 170. The calculations in this calculation database 160 are stored in a structured form and are structured according to generic parts list 120 and cost type list 130.

The comparison with the calculations determined and selected includes the following elements:
a table for a breakdown by components,
a graphic display of a breakdown by components,
a table for a breakdown by cost types,
a graphic display of a breakdown by cost types.

The table for a breakdown by components has six columns. The first column shows the names of the parts of the selected product component, i.e., in this example the names of the subparts of selected main part “defroster vent, outside left.” The second, third, and fourth columns show selected calculations K_1, K_2, K_3. The fifth column may be used for generating another optimal calculation as described below. The table includes one row for each subpart of the selected main part and another row for the total cost of acquisition of the selected main part. The cost of acquisition of the particular subpart included in the acquisition cost of the main part “defroster vent, outside left” is entered into the fields of the table. An example: assume that cost x_3.2 is entered into the field belonging to subpart “rear slats” of the main part “defroster vent, outside left” and belonging to the column for calculation K_2. Cost x_2 is entered into the field belonging to the row for the total acquisition cost of the main part and belonging to the column for calculation K_2. This means that according to calculation K_2, the main part is responsible for acquisition costs in the amount of x_2. Of these costs, a cost in the amount of x_3.2 is attributed to the subpart “rear slats.”

FIG. 7 shows a comparison of three calculations K_1, K_2, K_3 for the installation cost of the main part “defroster vent, outside left” with a breakdown by subparts. In calculation K_2, the sum of costs x1.2, . . . , x8.2 for the subparts yields acquisition costs x.1 for the main part. Assembly cost y1.2 and logistics cost y2.2 of the vehicle manufacturer are added to acquisition cost x.1, yielding installation cost y1. This installation cost must be paid by the automobile manufacturer to install in a vehicle one of the s2 outside left defroster vents thus acquired.

The optimal calculation is generated from five calculations K_1, . . . , K_5 on request by the user and is also related to the selected main part “defroster vent, outside left.” The most favorable of the three values is automatically selected for a subpart in each row. In the row for the subpart “rear slats,” x3.3 is selected because this value is the most favorable of three values x3.1, x3.2, and x3.3 for subpart “rear slats.” This is done for all subparts and also for the assembly costs and the logistics costs. The most favorable value is shown in bold in FIG. 7. Instead of the automatically selected value, the user may select another value and modify the value entered in the fifth column. The values in the fifth column are in turn added up, yielding:
X1.2+x2.3+x3.3+ . . . +x8.1=x.4 and
x.4+y1.3+y2.1=y4.

This optimal calculation provides suggestions for technical improvements, e.g., for an embodiment of subparts resulting in lower costs.

The graphic display of a breakdown by parts shows the contents of the table just described in graphic form. For example, the breakdown of costs among subparts is represented graphically by five bar graphs or five pie charts for the five selected calculations or by a bar graph having five bars per subpart.

Similarly, a table showing a comparison with a breakdown by cost type is also generated and displayed. In the example shown in FIG. 8, the user has specified the six cost types shown.

Functions from the subgroup “generate and display new comparisons for an attribute of the calculations” are described below as an example. The user specifies, for example, that he would like to generate a comparison related to different components of the same supplier. The user makes the following stipulations:
The user selects a supplier from supplier list 140.
The user optionally limits the search to certain types of cost calculations, e.g., negotiation results and bids. Without such a restriction, the search will be directed to calculations of all types.
The user will optimally limit the search to certain product components. For example, he will specify that a search should be conducted only in the subsystem “dashboard and center console vents.” A search is then conducted for calculations to this subsystem and the main parts and subparts contained in the subsystem according to generic parts list 120. Or the user selects multiple main parts belonging to different function modules. Without such a restriction, the search will include calculations for all product components.

For example, the user may specify that the comparison is to include all calculations originating from a previously selected supplier. No restriction is established with regard to the type of calculation or the product component. The device determines all calculations stored in calculation database 160 related to this supplier address. Calculations related to bids by or results of negotiations with this supplier as well as estimates, etc. by the vehicle manufacturer are included here.

First, a brief comparison of the calculations so determined is generated. This brief comparison shows the following information for each calculation:
the vehicle type,
the product component,
and the type of calculation.

The user selects some or all calculations from this brief comparison. A comparison for the selected calculation by analogy with the comparison described above is generated. Instead of the particular supplier, now the particular product component to which the calculation is related is shown in the tables.

The user also has an opportunity to restrict another attribute of a calculation. For example, he may specify a certain material. He does not make any other restrictions. All the calculations related to product components using the selected material for their manufacture are determined. The brief comparison generated first shows the following for each calculation so determined:
the vehicle type,
the product component,
the supplier,
and the type of calculation.

The user selects some or all of the calculations so determined and a comparison of the selected calculations is generated. For example, the amount of material used for a certain component may be determined from this comparison. This makes it possible to derive suggestions for a high or low amount of waste when using the material in manufacturing. The calculations also show the particular price assumed for the material, e.g., the price per kg. The comparison of the particular prices reveals possible savings.

The user may also make a restriction for several of the attributes, e.g., may select a material and a supplier. Or the user selects a resource, e.g., the resource “worker” and a vehicle segment.

As described above, the user sets a name for each comparison generated according to his specifications. The user may optionally describe the comparison using plain text. These specifications are saved as the user's instructions in a comparison database 161. This allows them to be reused later. Instead of generating anew a specification that has already been compiled, a user need only select a specification in comparison database 161.

Rather than the comparison thus generated, only the specification, e.g., the selected product component and the definition of the duration of validity, is preferably saved in comparison database 161. On request by the user, a new comparison is generated later according to this specification. When generating this comparison anew, the device will usually determine additional and/or other calculations than those used the first time it was generated. For example, calculation database 160 is supplemented by additional calculations for the selected component. Or a calculation performed the first time is no longer the most recent calculation for that component and for the particular vehicle type, which is why another calculation, namely a newer calculation, is performed.

A unit for filling lists 110, 120, 121, 130, 140 and databases 150, 160 are present on at least one network client computer 20.1, 20.2. This unit, preferably implemented with the help of a database management system, permits the following operations:
Generating, processing, and deleting a data record for a vehicle type and a data record for a vehicle segment and storing the changes in electronic vehicle list 110, linking a data record for a vehicle type to a data record for a vehicle segment,
Generating, processing, and deleting a data record for a product component and saving the changes in generic parts list 120, supplementing, processing, and deleting descriptions of features of a product component and the list of characteristics of this feature,
Generating, processing, and deleting a data record for a design module and saving the changes in electronic list 121 of design modules,
Generating, processing, and deleting a data record for a cost type and saving the changes in electronic list 130 of cost types,
Generating, processing, and deleting a data record for a supplier and saving the changes in electronic supplier list 140,
Generating, processing, and deleting a data record for a description of a product component and saving the changes in electronic description database 150,
Generating, processing, and deleting a data record for a calculation and saving the changes in electronic calculation database 160.

Generic parts list 120 is preferably updated as needed, in particular when a new subsystem, e.g., a navigation system, is being offered for the first time. The employee specifies the list of characteristics for each feature and determines whether the feature requires numbers or symbols as characteristics. A feature “weight” requires a number, but a feature “manufacturing methods” requires a symbol.

An employee generating a data record for a description of a product component specifies to which component of generic parts list 120 and to which vehicle type(s) this description refers. In addition, the employee specifies characteristics of features that are in effect for this vehicle type. In doing so, he selects for a feature either a characteristic from the list of characteristics saved in generic parts list 120 or he supplements the list of characteristics by adding an additional characteristic. The employee specifies which optional parts of a product component occur in this vehicle type and which do not.

The device preferably includes rules which check the characteristics of features for consistency and plausibility. For example, the feature “weight” is defined for the main part “defroster vent, outside left” and also for all its subparts. The employee specifies a characteristic, i.e., a value for the weight of the main part and values for the weight of each subpart. The possibility of defining the weight of the main part separately is expedient, so that the weight feature of the main part is provided with a value even when the breakdown of the main part in generic parts list 120 is not yet complete. The check rule forms the sum of the weights of the subparts, compares them with the weight of the main part, and generates a warning message to the employee when there is a deviation. If the weight of the main part is less than the sum of the weights of its subparts, there is obviously an error.

An employee who generates a data record for a calculation will specify to which component of generic parts list 120 and to which vehicle type(s) this description refers. For example, the employee assigns a description of a product component to the calculation, having thereby assigned the component and vehicle types. The employee assigns attribute values, e.g., a validity period of time and a supplier from supplier list 140 to other attributes of the calculation.

To determine the manufacturing costs of a product component, the employee defines the manufacturing steps, i.e., the work operations performed in the manufacture of the component. This definition may be specific to the component in a certain vehicle type—then the definition is assigned to the description in description database 150—or may be valid fundamentally for the component, regardless of vehicle type—then the definition in generic parts list 120 is assigned to the component. As a rule, the manufacturing steps are assigned to a subpart. Many manufacturing steps refer to a complete main part, e.g., chucking and testing the main part, and therefore are assigned to the main part. A manufacturing step may be broken down into manufacturing substeps.

The manufacturing cost of manufacturing a component is preferably determined as individual cost items as a function of the following parameters:
the number of parts in which this component is manufactured,
the usage times of the machines used in the manufacture of the component, expressed in minutes per component manufactured, for example,
the labor time of workers involved in the manufacture of the component, expressed, e.g., in minutes per component,
a definition of how many machines one worker is operating at the same time,
an hourly rate for usage of each machine, including the cost of acquisition or development of the machine, e.g., in the form of depreciation and the cost of operation,
hourly wage rates for the workers.

An automatically analyzable selection logic is preferably used to identify the machines required for manufacturing.

1-16. (canceled)

17. A device for comparing calculations for product components in different product types, the device comprising:
an electronic product type listing of a plurality of product types;
an electronic parts lists valid for each product type in the product type listing and including a breakdown of a product of the product type into a plurality of components and including at least one feature of each component;
an electronic component description database including a plurality of automatically analyzable component descriptions for each component occurring in the parts list, each component description corresponding to at least one of the plurality of components and being valid for at least one product type in the product type listing and including at least one characteristic of the at least one feature;
an electronic calculation database having calculations corresponding to a component occurring in the parts list and to a product type in the product type listing;
a component selecting unit configured to select at least one component occurring in the parts list;
a determining unit configured to automatically determine all calculations in the calculation database relating to a selected component and configured to determine the product types of the determined calculations; and
a comparison unit configured to generate a comparison of a plurality of determined calculations and the component descriptions in effect for a selected component and for determined product types.

18. The device as recited in claim 17, wherein:
the parts list includes a further breakdown of each component into one or more parts;
at least one calculation in the calculation database includes information about a percentage of a part in the calculation of a respective component;
the comparison unit is configured to generate a partial comparison for each part of the selected component, wherein each partial comparison includes the percentage of the part of the calculation of the comparison.

19. The device as recited in claim 18, wherein the comparison unit is configured to generate a configuration comparison of the characteristics of the features of the parts in the product types and configured to insert the configuration comparison into the comparison.

20. The device as recited in claim 17, further comprising:
a product type selecting unit configured to select product types occurring in the product type listing, and wherein the determining unit is configured to determine all calculations relating to a selected component and a selected product type.

21. The device as recited in claim 17, wherein the calculations relate to costs and further comprising an electronic cost type list including a plurality of cost types for each calculation, the cost type list being valid for all components of the parts list and all product types of the listing, wherein each calculation includes a partial calculation for each cost type in the cost type list, and wherein the comparison unit is configured to break down a comparison into the cost types of the cost type list.

22. The device as recited in claim 21, further comprising a cost type selecting unit configured to select at least one cost type occurring in the cost type list and wherein the comparison unit is configured to automatically remove cost types not selected from the comparison.

23. The device as recited in claim 21, further comprising:
a calculation selecting unit configured to select a calculation contained in the comparison for each cost type of the cost type list; and
a cost type calculation unit configured to generate a calculation for a selected component, each calculation having a partial calculation for a respective cost type of the cost type list, the partial calculation for a cost type being equal to the partial calculation of the calculation selected for the cost type.

24. The device as recited in claim 17, further comprising:
an electronic attribute list having attributes assignable to the calculations and having possible values of the attributes, the attribute list being valid for all components of the parts list and all product types of the listing, wherein the calculations in the calculation database include attribute-attribute value pairs, each attribute occurring in the attribute list and each attribute value being a possible value of the attribute; and
an attribute selecting unit configured to select at least one attribute of the attribute list and one possible value of a selected attribute, wherein the determining unit is configured to automatically determining all calculations including at least one selected attribute-attribute value pair.

25. The device as recited in claim 24, wherein the attribute list includes at least one of the following attributes:
a period of time to which the calculation refers;
a material used to manufacture at least one product component;
a supplier of at least one product component;
a manufacturing method used in the manufacture of at least one product component;
a resource used in the manufacture of at least one product component; and
a region in which at least one product component is manufactured.

26. The device as recited in claim 17, further comprising:
a calculation unit configured to generate the calculations using the electronic parts list; and
a memory unit configured to save the calculations in the calculation database.

27. A method for comparing calculations for product components in different product types, the method comprising:
providing an electronic product type listing of a plurality of product types, each product type corresponding to one or more products;
providing an electronic parts list valid for each product of the product types including a breakdown of each product into a plurality of components and including at least one feature of each component;
saving a plurality of automatically analyzable component descriptions for each component occurring in the parts list in an electronic description database, each component description being valid for at least one product type occurring in the listing and including at least one characteristic of at least one feature of each component;
saving a plurality of calculations relating to a component occurring in the parts list and a product type occurring in the product type listing in an electronic calculation database;
selecting at least one component occurring in the parts list;
determining a set of the plurality of calculations that relate to the selected component in the electronic calculation database;
determining a set of the plurality of component descriptions that are valid for the selected component and for the product types to which the set of calculations refer; and
generating a comparison of the set of calculations and the set of component descriptions.

28. The method as recited in claim 27, wherein the saving, selecting, determining and generating steps are performed using a data processing system.

29. The method as recited in claim 27, wherein the calculations refer to costs and further comprising:
providing an electronic cost type list having cost types of a calculation, the cost type list being valid for all components and all product types, wherein the determining of the set of calculations includes determining one partial calculation for each cost type of the cost type list;
selecting a calculation for each cost type of the cost type list; and
generating a further calculation for the selected component having a partial calculation per cost type of the cost type list, the partial calculation of the selected calculation for the cost type being used the cost type in the further calculation.

30. A method for comparing calculations for product components in different product types, the method comprising:
providing an electronic product type listing of a plurality of product types, each product type corresponding to one or more products,
providing an electronic attribute list containing attributes of a calculation and possible values of the attributes, the attribute list being valid for all components and all product types of the listing;
providing an electronic parts list valid for each product of the product types of the listing, and including a breakdown of each product into a plurality of components and at least one features of each component;
saving automatically analyzable component descriptions for each component occurring in the parts list in an electronic description database, each component description being valid for at least one product type occurring in the listing and including characteristics of the features of the component in this product type,
saving calculations relating to at least one component occurring in the parts list and at least one product type occurring in the product listing, and assigning attribute-attribute value pairs comprising attributes and attribute values of the attribute list in an electronic calculation database;
selecting at least one attribute of the attribute list and at least one possible value of a selected attribute;
determining a set of the calculations saved in the calculation database to which a selected attribute-attribute value pair is assigned;
determining a set of component descriptions that are valid for the component and for the product types corresponding to the set of calculations; and
generating a comparison of the set of calculations and the set of component descriptions.

31. The method as recited in claim 30, wherein the saving, selecting, determining, and generating steps are performed using a data processing system:

32. The method as recited in claim 30, wherein the attribute list comprising possible attributes of a calculation includes at least one of the following attributes:
a period of time to which the calculation refers;
a material used to manufacture at least one product component;
a supplier of at least one product component;
a manufacturing method used in the manufacture of at least one product component;
a resource used in the manufacture of at least one product component; and
a region in which at least one product component is manufactured.

33. A computer program product that is directly loadable into the internal memory of a computer and includes software segments configured to implement the method as recited claim 27 when the product runs on a computer.

34. The computer program product saved on a computer-readable medium and having computer-readable program means causing the computer to execute a method as recited in claim 27.
